(19) United States
(12) Patent Application Publication
(10) Pub. No.: US 2010/0260234 A1
(43) Pub. Date: Oct. 14, 2010

(54) CLOSED-LOOP TRANSMISSION FEEDBACK IN WIRELESS COMMUNICATION SYSTEMS

(75) Inventors: Timothy A. Thomas, Palatine, IL (US); William J. Hillery, Lafayette, IN (US); Bishwarup Mondal, Oak Park, IL (US); Frederick W. Vook, Schaumburg, IL (US); Fan Wang, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/421,573

(22) Filed: Apr. 9, 2009

(51) Int. Cl. H04B 1/707

(52) U.S. Cl. 375/141; 375/146; 375/E01.002

(57) ABSTRACT

Channel information feedback takes place by calculating channel information to feed back to the base station. The channel quality information is spread by a remote unit with spreading codes from mutually unbiased bases and transmitted to the base station. The advantages of spreading the feedback channel are that multiple mobiles can send their feedback on the same time-frequency resources making the feedback very efficient and also improving feedback performance through orthogonal spreading which gives a spreading gain above noise and interference. Using the spreading codes from mutually unbiased bases can reduce interference across sectors.

### FIELD OF THE DISCLOSURE

The present disclosure relates generally to wireless communications and more particularly to closed-loop transmission feedback in wireless communication systems and methods.

### BACKGROUND

In wireless communication systems, transmission techniques involving multiple antennas are often categorized as open-loop or closed-loop, depending on the level or degree of channel response information used by the transmission algorithm. Open-loop techniques do not rely on the information of the spatial channel response between the transmitting device and the receiving device. They typically involve either no feedback or the feedback of the long term statistical information that a base unit may use to choose between different open loop techniques. Open-loop techniques include transmit diversity, delay diversity, and space-time coding techniques such as the Alamouti space-time block code.

Closed-loop transmission techniques utilize knowledge of the channel response to weight the information transmitted from multiple antennas. To enable a closed-loop transmit array to operate adaptively, the array must apply the transmit weights derived from the channel response, its statistics or characteristics, or a combination thereof. There are several methodologies for enabling closed-loop transmission. These are discussed in the context of the downlink of a cellular communication system in which a base station (BS) (sometimes referred to as a base unit or access point or node-B) with multiple antennas transmits to a mobile station (MS) (sometimes referred to as a mobile or remote unit or user equipment) having one or more receive antennas and one or more transmit antennas. The MS may not necessarily have the same number of transmit antennas as receive antennas. Exemplary closed-loop methodologies include adaptive transmit beam-forming, closed-loop single-user MIMO, and closed-loop multi-user MIMO. In these examples, the transmitter applies weighting coefficients that are derived according to an optimization algorithm to control characteristics of the transmitted signal energy.

One methodology for enabling closed-loop transmission is codebook index feedback in which both the BS and MS maintain a finite codebook of possible transmit weight vectors or matrices, depending on the number of simultaneous transmit beams being formed. The MS measures the downlink multi-antenna channel response and computes the transmit weight vector or matrix that is best used to transmit information. The MS then transmits the index into the codebook back to the BS, where the index into the codebook is often called a Precoding Matrix Index (PMI). The BS uses the transmit weight vector or matrix corresponding to the index fed back by the MS. Codebook index feedback can be applied to both frequency division duplex (FDD) and time division duplex (TDD) systems.

Another methodology for enabling closed-loop transmission is direct channel feedback (DCFB), wherein the MS measures the downlink channel response and encodes that channel response as an analog signal to be conveyed on the uplink. The downlink channel response estimates are encoded along with known pilot signals that enable the BS to estimate the analog values of the downlink channel estimates. DCFB can be applied to both FDD and TDD systems.

Another methodology for enabling closed-loop transmission is analog covariance matrix or analog eigenvector feedback. In covariance feedback the MS measures the downlink channel response, computes a covariance matrix for the band of interest, and then feeds back the values of the covariance matrix in an analog fashion to the BS. For eigenvector feedback, the MS obtains a covariance matrix similar to that of covariance feedback but then computes the dominant eigenvector or eigenvectors of the covariance matrix and feeds back the eigenvector or eigenvectors in an analog fashion to the BS.

While the above-techniques may provide an efficient method for channel feedback, the techniques are not robust enough to handle poor channel conditions including high interference levels nor do they enable the feedback channel to support multiple users. Thus there is a need for an improved feedback methodology to enable closed-loop transmit antenna array techniques in wireless communication systems that accommodates poor channel conditions as well as allows multiple users to be supported by a single feedback channel.

### BRIEF DESCRIPTION OF THE DRAWINGS

FIG. 1 is a wireless communication system.

FIG. 2 is a block diagram of a closed-loop transmit antenna array communicating a single data stream to a receiving device.

FIG. 3 is a block diagram of a closed-loop transmit antenna array communicating multiple data streams to a receiving device.

FIG. 4 is a block diagram of a frequency domain-oriented broadband transmission system employing a closed-loop transmit antenna array.

FIG. 5 is a diagram showing the preferred embodiment for the analog feedback (AFB) subchannel for two transmit antennas.

FIG. 6 is a diagram showing an alternate embodiment for the AFB subchannel for two transmit antennas.

FIG. 7 is a diagram showing the preferred embodiment for the AFB subchannel for four transmit antennas.

FIG. 8 is a diagram showing an alternate embodiment for the AFB subchannel for four transmit antennas.

FIG. 9 is a diagram showing the preferred embodiment for the AFB subchannel for eight transmit antennas.

FIG. 10 is a diagram showing an alternate embodiment for the AFB subchannel for eight transmit antennas.

FIG. 11 is a block diagram of a remote unit using the AFB subchannel.

FIG. 12 is a block diagram for a base unit requesting an AFB subchannel and receiving an AFB subchannel from a remote unit.

FIG. 13 is a flow chart showing operation of the AFB subchannel at a remote unit.

FIG. 14 is a flow chart showing operation of requesting and receiving an AFB subchannel at a base unit.

FIG. 15 is a diagram showing a preferred embodiment for a subchannel carrying modulation symbols.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

In order to address the above-mentioned issues, a method and apparatus for providing channel feedback is provided herein. During operation, a mobile unit will receive a request from a base station to provide channel information to the base station. The channel information is spread by a remote unit and transmitted to the base station. The advantages of spreading the feedback channel are that multiple mobiles can send their channel information feedback (e.g., analog feedback) on the same time-frequency resources making the feedback very efficient and also improving the quality of the analog feedback through orthogonal spreading which gives a spreading gain above noise and interference.

To help further improve the spreading in the presence of intra-cell or inter-cell interference, a particular spreading code designed from mutually unbiased bases (MUBs) can be used. The MUB spreading codes provide a set of orthogonal codes where a different set can be assigned to different sectors and/or base stations (BSs). Any two codes within one set are orthogonal and any pair of codes taken from two different sets are guaranteed to have a certain low cross-correlation level resulting in a low interference level.

The present invention encompasses a method for closed loop feedback in a communication system. The method comprising the steps of receiving, by a mobile unit, a request to feed back channel information, the request sent from a base station, determining, by the mobile unit, channel information to feed back to the base station, and spreading, by the mobile unit, the channel information. The mobile unit the transmits the spread channel information to the base station.

The present invention additionally encompasses a method for transmission in a communication system. The method comprises the steps of receiving, by a mobile unit, a request for one or more digital modulation symbol feedback, the request sent from a base station, spreading, by the mobile unit, one or more digital modulation symbols with a spreading code from a mutually unbiased basis across multiple subcarriers in frequency or multiple symbols in time or both, and transmitting, by the mobile unit, the spread one or more digital modulation symbols.

The present invention additionally encompasses a method comprising the steps of determining by a base station that channel information is needed regarding a channel existing between the base station and a mobile unit, sending from the base station, a request for channel feedback to the mobile unit, and in response to the sent channel feedback request, receiving at the base station the channel feedback request in the form of spread information.

The present invention additionally encompasses an apparatus comprising a transceiver receiving a request to feed back channel information, the request sent from a base station, calculation circuitry determining the channel information to feed back to the base station, spreading circuitry spreading the channel information, and the transceiver circuitry transmitting the spread channel information to the base station.

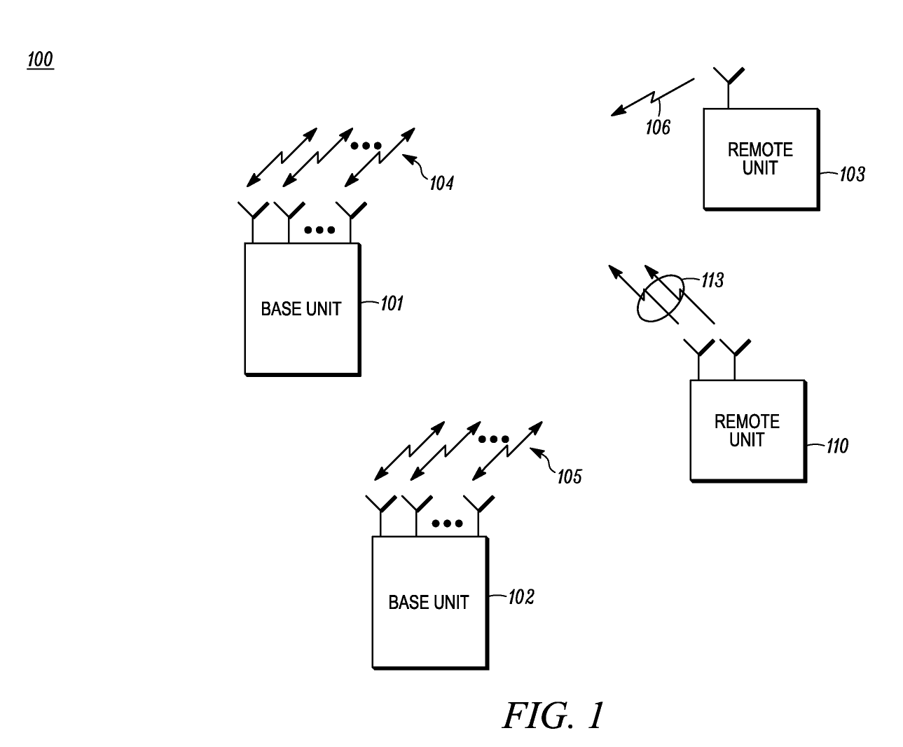

In FIG. 1, the wireless communication system 100 includes one or more fixed base infrastructure units forming a network distributed over a geographical region. The base unit may also be referred to as an access point, access terminal, BS, Node-B, eNode-B, or by other terminology used in the art. In FIG. 1, the one or more base units 101 and 102 serve a number of remote units 103 and 110 within a serving area, for example, a cell, or within a cell sector. In some systems, one or more base units are communicably coupled to a controller forming an access network that is communicably coupled to one or more core networks. The disclosure however is not intended to be limited to any particular wireless communication system.

Generally, the serving base units 101 and 102 transmit downlink communication signals 104 and 105 to remote units in the time and/or frequency domain. Remote units 103 and 110 communicate with one or more base units 101 and 102 via uplink communication signals 106 and 113. The one or more base units may comprise one or more transmitters and one or more receivers that serve the remote units. The remote units may be fixed or mobile user terminals. The remote units may also be referred to as subscriber units, mobile stations (MSs), users, terminals, subscriber stations, user equipment (UE), user terminals, or by other terminology used in the art. The remote units may also comprise one or more transmitters and one or more receivers. The remote units may have half duplex (HD) or full duplex (FD) transceivers. Half-duplex transceivers do not transmit and receive simultaneously whereas full duplex terminals do.

In the preferred embodiment, the communication system utilizes orthogonal frequency division multiple access (OFDMA) or a multi-carrier based architecture on the downlink and for uplink transmissions. Exemplary OFDMA based protocols include the Long Term Evolution (LTE) of the 3GPP UMTS standard and IEEE 802.16 standard. Although the preferred embodiment utilized OFDMA, other modulation methods may also be employed such as interleaved frequency-division multiple access (IFDMA), DFT spread OFDM, multi-carrier code-division multiple access (MC-CDMA), multi-carrier direct sequence CDMA (MC-DS-CDMA), Orthogonal Frequency and Code Division Multiplexing (OFCDM), or cyclic-prefix single carrier.

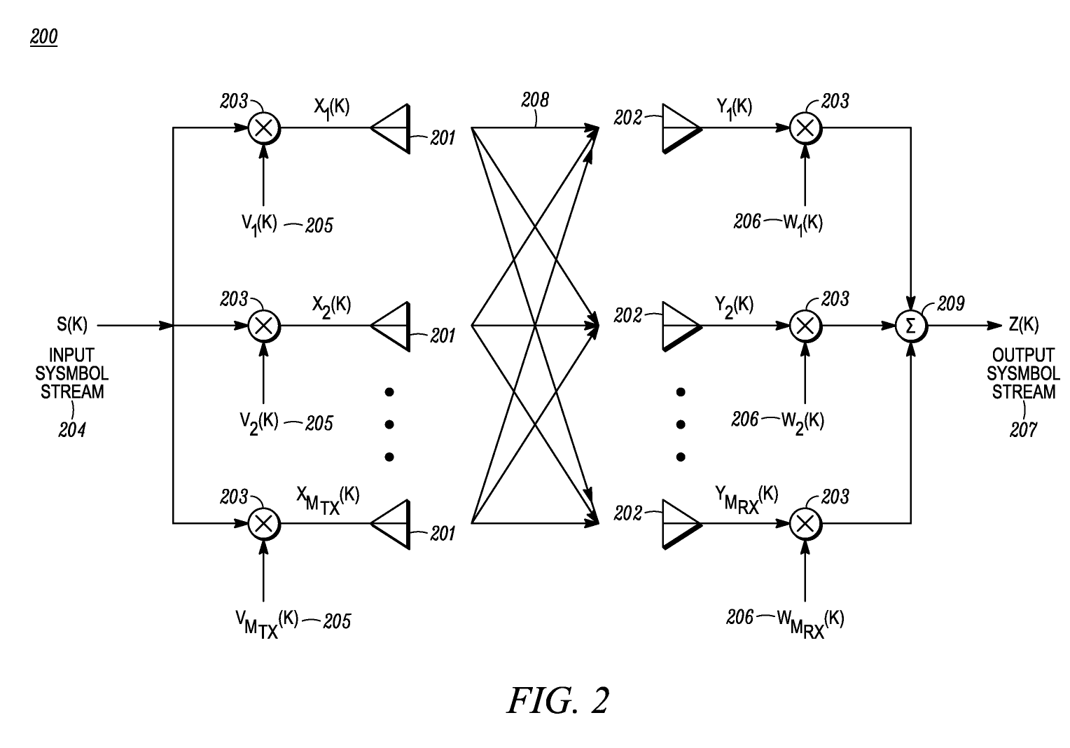

FIG. 2 is a block diagram of a closed-loop transmit antenna array as part of a base unit communicating a single data stream to a receiving device as part of a remote unit having one or more receive antennas. Input stream 204 is multiplied by transmit weights 205 using multipliers 203 before being fed to the multiple transmit antennas 201. Multiplying input stream 204 by transmit weights 205, where the transmit weights are based on at least a partial channel response, is an example of tailoring a spatial characteristic of the transmission. Methods for determining the transmit weights from the channel response are discussed more fully below. The signals transmitted from the multiple transmit antennas 201 propagate through a matrix channel 208 and are received by multiple receive antennas 202. The signals received on the multiple receive antennas 202 are multiplied by receive weights 206 using multipliers 203 and summed by a summation device 209 to produce an output symbol stream 207. In embodiments where the transmitter has only a single antenna, the spatial characteristic of the transmit signal cannot be tailored. However, other characteristics of the transmit signal may be tailored based on at least a partial channel response, such as the complex gain of each sub-carrier (e.g., in a pre-equalization application), or the modulation and coding used on the sub-carriers of the transmit signal.

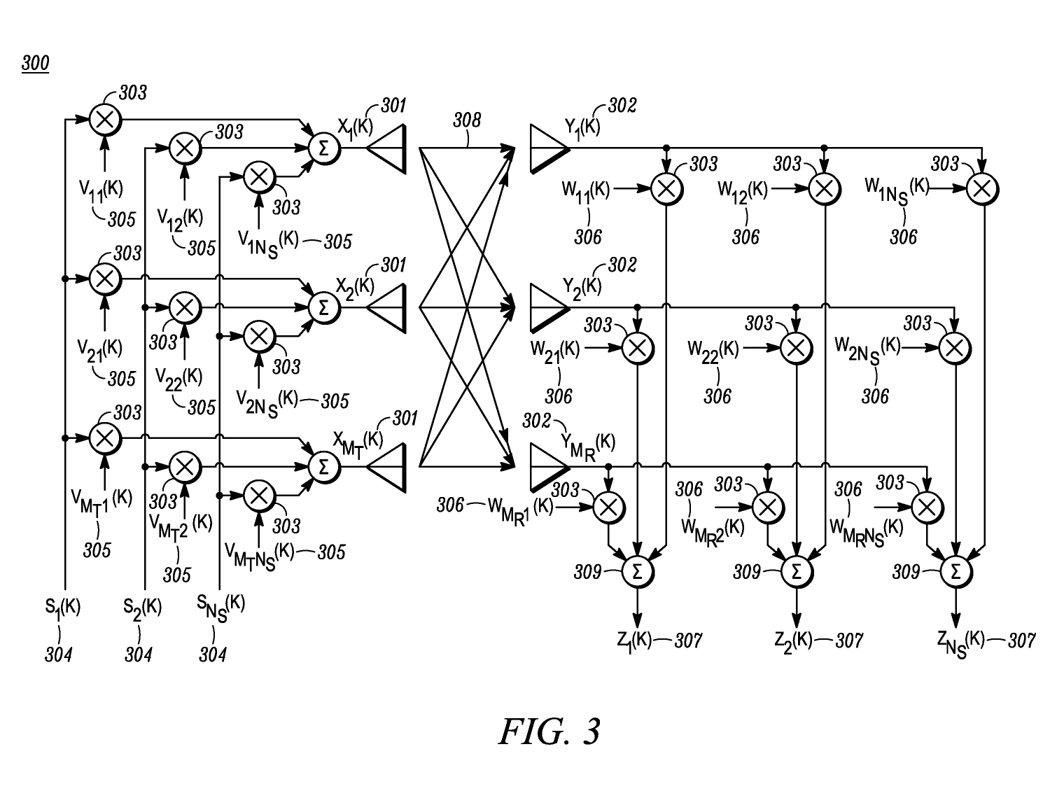

FIG. 3 is a block diagram of a closed-loop transmit antenna array as part of a base unit communicating multiple data streams to a remote unit having one or more receive antennas, for example, a MIMO system. Multiple input streams 304 are multiplied by transmit weights 305 using multipliers 303 before being fed to the multiple transmit antennas 301. The signals transmitted from the multiple transmit antennas 301 propagate through a matrix channel 308 and are received by multiple receive antennas 302. The signals received on the multiple receive antennas 302 are multiplied by receive weights 306 using multipliers 303 and summed by summation devices 309 to produce the multiple output symbol streams 307. Multiplying input streams 304 by transmit weights 305 where the transmit weights are based on at least a partial channel response is another example of tailoring a spatial characteristic of the transmission. Other schemes for producing the output symbol streams 307 are possible, such as maximum likelihood detection or successive cancellation that may or may not use the receive weights 306 and the multipliers 303.

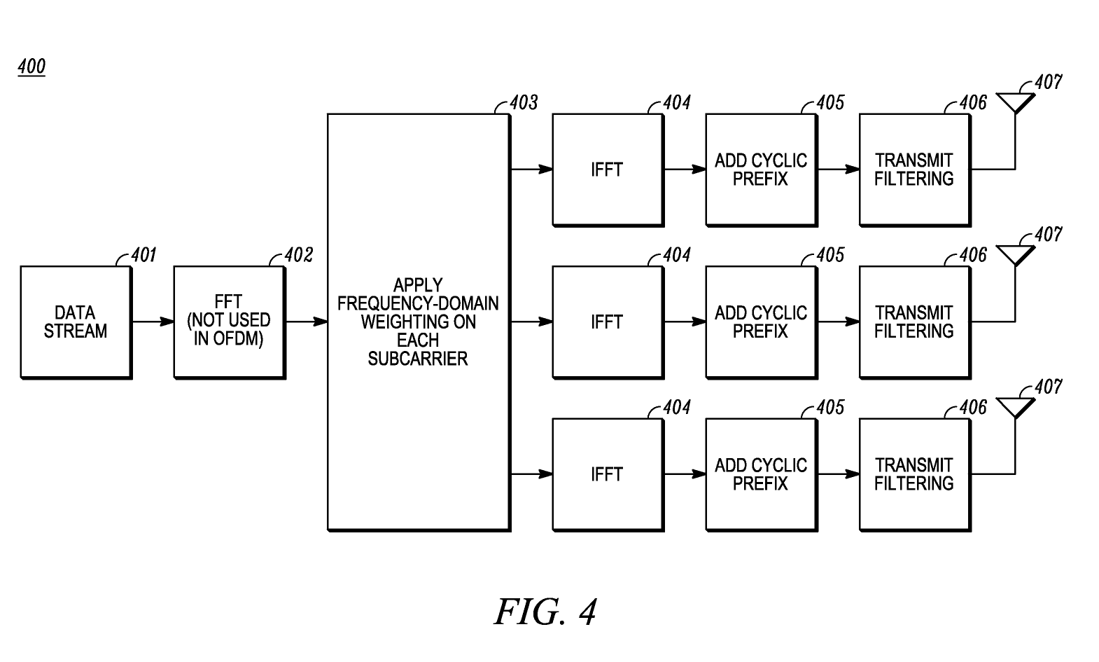

FIG. 4 is a block diagram of a frequency-domain oriented transmission system such as OFDM or cyclic prefix single carrier (CP-Single Carrier) in which the transmission techniques of FIG. 2 and FIG. 3 are performed in the frequency domain prior to transmission. In a CP-Single Carrier system, one or more data streams 401 are first brought into the frequency domain with one or more fast Fourier transforms (FFTS) 402 and the frequency domain data streams are weighted with frequency domain weighting apparatus 403. In OFDM, the one or more data streams 401 are sent directly to frequency domain weighting apparatus 403 without the use of FFT 402. The frequency domain weighting apparatus 403 implements the weighting function shown in the transmit portion of FIG. 2 and FIG. 3 on each sub-carrier or frequency bin in the frequency domain. Thus, the transmit signal can be tailored either spatially, or in frequency, or both with this type of a system. The outputs of the frequency domain weighting apparatus 403 are then brought back into the time domain with IFFTs 404. Cyclic prefixes are added 405 as is known in the art. Transmit filtering 406 is then performed before sending the transmitted signals to the transmit antennas 407.

A spatial covariance matrix or more generally 'spatial transmit covariance matrix' captures the correlations between various transmit antennas as experienced in a certain propagation environment. It also captures the received power at the terminal corresponding to each transmit antenna. An instantaneous covariance matrix can be defined for each data subcarrier i, based on the downlink channel estimates available at a time instant (hence can also be referred to as short-term covariance matrix)

Rᵢ=Hᵢ^{H}Hᵢ (1.1)

where Hᵢ is the N_{R}×N_{T} channel matrix estimated by the terminal on the downlink. A remote unit can accumulate or average the per-subcarrier instantaneous or short-term covariance matrix over multiple subcarriers. A narrow band covariance matrix is accumulated over subcarriers that encompass a small portion of the operational bandwidth (sometimes referred to as “sub-band”). A wideband or broadband covariance matrix is accumulated over the entire band or a large portion of the band. A remote unit can also accumulate an instantaneous covariance matrix over time to obtain a long-term statistical spatial covariance matrix. In another form, a remote unit may compute the above estimate by including only the rows in the channel matrix corresponding to a subset of the receive antennas on which measurements are available. Also note that a remote unit may obtain the covariance matrix without having to estimate the channel explicitly, for example, by correlating the received pilots sent from each transmit antenna. In an alternate embodiment, the spatial covariance matrix may be replaced by an (any) Hermitian matrix. The coefficients of the Hermitian matrix may be analog (meaning not quantized and coded or modulated with a digital modulation technique e.g. QPSK, QAM) and may or may not be a direct function of the spatial covariance matrix. Examples of such matrices include σ²I, R+σ²I where I is an N_{T}×N_{T} identity matrix, σ² is a real scalar and R is an N_{T}×N_{T} spatial covariance matrix.

Utilizing the covariance matrix, the remote unit may compute the dominant eigenvectors of the covariance matrix and feedback the eigenvectors to the base unit instead of feeding back the covariance matrix. The N_{d} dominant eigenvectors of the covariance matrix are the N_{d} eigenvectors of the covariance matrix corresponding to the largest eigenvalues. This type of feedback is known as eigenvector or singular vector feedback.

As suggested above, the base unit uses the spatial covariance matrix or matrices or the dominant eigenvectors to compute transmit weights and for other purposes as will become more fully apparent from the discussion herein. In one embodiment, the remote unit computes the spatial covariance matrix based on a measured downlink matrix channel response. The computation of spatial covariance matrices is known generally by those having ordinary skill in the art. The present disclosure is not intended to be limited to any particular method or technique of computing a spatial covariance matrix. In some implementations, the base unit indicates which portion of the operational bandwidth for which the one or more spatial covariance matrices should be computed by the remote unit. This indication could be explicit or implied.

In one implementation, the remote unit computes a spatial covariance matrix and transmits the matrix or a representation thereof to the base unit. In another implementation the remote unit computes the dominant eigenvector(s) of the covariance matrix and transmits the eigenvector(s) or a representation thereof to the base unit. In one embodiment, the base unit uses the spatial covariance matrix or dominant eigenvector(s) received from the remote unit to compute beamforming weights (i.e., complex-valued weighting factors for each transmit antenna). In one embodiment, a base unit may use the covariance matrix accumulated over the entire band (or dominant eigenvector(s) computed from the covariance matrix accumulated over the entire band) for computing the beamforming weights that will then be the same on all subcarriers. In another embodiment, a base unit may use the covariance matrix specific to a portion of the band (or the dominant eigenvector(s) computed from the covariance matrix specific to a portion of the band) for beamforming only in the corresponding portion of the band. In one embodiment, the base unit may request periodic feedback of the covariance matrix or its dominant eigenvector(s) corresponding to a portion of the band or its entirety. In another embodiment, the base unit commands the remote unit to compute and feedback the covariance matrix or the dominant eigenvector(s) of the covariance matrix on an as-needed basis or on a periodic basis.

In another embodiment, the base unit uses a covariance matrix or dominant eigenvector(s) that is (are) fed back from the remote unit to compute multiple transmit weight vectors for use in multi-stream beamforming or closed-loop MIMO applications where multiple spatial channels are simultaneously formed (one formed by each transmit weight vector) so as to realize a spatial multiplexing gain on the time-frequency resources used for transmission to the mobile unit. The remote unit receiving transmission may or may not be served by the base-unit. A serving base unit for a particular remote unit is defined as one that transmits primary control information to the remote unit. When the remote unit is not served by the base-unit, the transmission may be referred to as a coordinated multi-point (CoMP) transmission.

In another embodiment, the base unit uses the covariance matrices or dominant eigenvector(s) fed back from multiple remote units to compute multiple transmit weight vectors for the purpose of realizing multi-user MIMO transmission (also called transmit Spatial Division Multiple Access (SDMA)) to multiple remote units simultaneously on the same time-frequency resources. One or more of the remote units receiving transmission may not be served by the base-unit. When the remote unit is not served by the base-unit, the transmission may be referred as a coordinated multi-point (CoMP) transmission.

In another implementation, the remote unit computes multiple spatial covariance matrices or dominant eigenvector(s) for the set of multiple covariance matrices that correspond to different portions of the operational band, and transmits the matrices or their associated dominant eigenvector(s) to the base unit per the allocation by the base unit. In one embodiment, the base unit uses the spatial covariance matrices or dominant eigenvectors received from the remote unit to compute transmit weights for frequency selective scheduling (FSS) applications. The group of subcarriers (frequency band) that are used to derive spatial covariance matrices can be chosen by a remote unit or by a base unit. The time gap from one feedback of this information to the next feedback can be decided by a remote unit or by a base unit based on factors such as remote unit moving speed, SNR, etc.

A covariance matrix feedback is obtained by summing the per-subcarrier covariance matrix defined in (1.1) over all the subcarriers in the entire band or a subset of subcarriers associated with a sub-band (or allocation), whose index can be denoted as j in the mathematical expressions below. Such association of a spatial covariance matrix to the entire or sub-band may be explicitly or implicitly signaled by the base unit.

The spatial covariance matrix accumulated over subcarriers that belong to the j^{th} sub-band can be written as

$$R = {\sum }_{i ∈ {B}_{j}} {H}_{i}^{H} {H}_{i} \qquad ( 1.2 )$$

where Bⱼ is the set of subcarriers associated with the band or allocation index. The matrix R is a N_{T}×N_{T} matrix which can be represented as below

$$R = [ \begin{matrix}{R}_{1 , 1} & {R}_{1 , 2} & … & {R}_{1 , {N}_{T}} \\ {R}_{2 , 1} & {R}_{2 , 2} & & {R}_{2 , {N}_{T}} \\ ⋮ & & ⋱ & \\ {R}_{{N}_{T} , 1} & {R}_{{N}_{T} , 2} & & {R}_{{N}_{T} , {N}_{T}}\end{matrix} ] \qquad ( 1.3 )$$

with N_{T}² entries where N_{T} denotes the number of transmit antennas.

Further, the spatial covariance matrix having multiple coefficients could be transformed into a set of mathematical coefficients. This could involve separate steps to reduce the amount of feedback information and/or indicate certain quality of the channel. The transformation produces a set of L analog coefficients.

[V₁, V₂, . . . V_{L}]ⱼ→A set of L analog coefficients that capture covariance matrix information of j^{th} sub-band (1.4)

In one embodiment, the transformation in the above embodiment involves extracting the unique entries of the covariance matrix that is typically a Hermitian matrix, and the unique elements are diagonal elements and additionally either the elements from the upper triangle or the lower triangle of the matrix. The number of unique elements is L=N_{T}(N_{T}+1)/2, down from N_{T}² total coefficients.

In another embodiment the selected elements of the matrix are normalized so that their mean transmit power is fixed to a constant value.

In another embodiment, the number of coefficients can be further reduced by one, by dividing the covariance matrix by the element located at the first row and first column for example, which is then normalized to one and which will not need to be fed back.

In another embodiment, the covariance matrix is transformed so that all the diagonal elements are equal which reduces the number of analog coefficients to L=N_{T}(N_{T}+1)/2−(N_{T}−1). An example of this transformation is shown below

$$μ = \frac{1}{{N}_{Tx}} {\sum }_{i = 1}^{{N}_{Tx}} {R}_{ii} \\ Φ = diag ( \sqrt{\frac{μ}{{R}_{11}}} , \sqrt{\frac{μ}{{R}_{22}}} , … \sqrt{\frac{μ}{{R}_{{N}_{Tx} {N}_{Tx}}}} ) \\ \tilde{R} = Φ R Φ \qquad ( 1.5 )$$

In another embodiment, diagonal elements are compressed by creating complex entries from them (i.e., exploiting the fact that R_{i,i} is real). Thus instead of needing N_{T} feedback entries for the diagonal elements, only N_{T}/2 entries are needed. These N_{T}/2 entries are given as (for m=1, . . . ,N_{T}/2):

dₘ=R_{2m-1,2m-1}+iR_{2m,2m} (1.6)

and the remaining off diagonal entries are sent back as their nominal values.

In another embodiment, the N_{d} dominant eigenvectors are obtained and each eigenvector is scaled by an associated scaling factor, resulting in a total of L=2N_{T} coefficients for example in the case of N_{d}=2 dominant eigenvectors.

In one implementation, the associated scaling factor can be a function of one or more eigenvalue of the spatial covariance matrix. Specifically, the scaling factor in the above embodiment could be the square root of the eigenvalue of the corresponding eigenvector. This information can be used at the base unit to reconstruct an approximation of the covariance matrix information, like reconstructing a reduced-rank estimate of the covariance matrix.

In an embodiment, the covariance matrix entries or the elements of the dominant eigenvector(s) are sent back as analog coefficients. In a more particular implementation, a set of “analog” coefficients are generated from coefficients of each covariance matrix or the dominant eigenvector(s). These analog coefficients are used to modulate the multiple channels of the feedback waveform. The term “analog coefficient” refers to the complex value as digitally stored in a processor, without being further quantized according to any finite alphabet constellation such as QPSK/QAM in a digital communication system.

In another embodiment, channel information including the covariance matrix entries or the elements of the dominant eigenvector(s) is encoded in digital form and mapped to digital modulation symbols (e.g., QPSK) for transmission to the BS. The channel information can be directly mapped to a digital modulation symbol, for example, the analog value can be mapped to the nearest 16 QAM constellation value. The channel information can also be quantized, encoded, and mapped to a digital modulation symbol.

As discussed above, prior-art techniques for channel feedback are not robust enough to handle poor channel conditions or strong intra-cell or inter-cell interference nor do they enable the feedback channel to support multiple users. In order to address these issues, the channel feedback described above may be spread using a spreading code. More particularly, the analog feedback may be encoded using a short spreading sequence such as a Walsh code or as will be described shortly, a spreading code chosen from a set of mutually unbiased bases (MUBs). The advantages of the spreading are that multiple mobiles can send their analog feedback on the same time-frequency resources making the feedback very efficient and also improving analog feedback through orthogonal spreading which gives a gain above noise and interference. A short spreading code chosen from MUBs may be used for spreading feedback information transmitted from remote units within a time-frequency resource. A time-frequency resource is comprised of multiple closely-spaced subcarriers in frequency and/or multiple closely-spaced symbols in time. This feedback information can be in digital form where modulation symbols from a constellation is spread using a MUB code. The feedback information can also be in analog form where complex coefficients (that are not mapped to a modulation symbol) are spread using a MUB code.

To understand the utility of the MUB for spreading, let us first give a definition of a MUB. In a D-dimensional space, two bases A and B are defined as mutually unbiased if:

| [symbol] (a, b) [symbol] ²=1/D, for any a ∈ A, and any b ∈ B

and <•, •> denotes the cosine of the angle between the two vectors a and b. Hence by using MUBs a low cross-correlation value is guaranteed between two spreading codes in different MUB sets because of the initial construction. It is known that D+1 such bases exist if D is a power of a prime number. In the particular case when D is a power of 2, it turns out that the D+1 MUBs can be constructed from the alphabet α where in the preferred embodiment, the alphabet consists of QPSK entries (i.e., 1, −1, +i and −i). The advantage of QPSK entries is that both the spreading and despreading operations can be accomplished with no multiplications and hence has a low computational complexity. In a particular dimension a set of bases that are mutually unbiased is not unique. The MUBs described, therefore, are specific examples to illustrate the application and a particular embodiment may contain any set of bases that are mutually unbiased.

In the case of D=2 (corresponding to a spreading by a factor of 2), 3 MUBs (the maximum possible for this dimension) includes bases A and B given as:

$$A = ( \frac{1}{\sqrt{2}} ) [ \begin{matrix}1 & 1 \\ 1 & - 1\end{matrix} ] , \\ B = ( \frac{1}{\sqrt{2}} ) [ \begin{matrix}1 & 1 \\ i & - i\end{matrix} ] ,$$

and also the 2×2 identity matrix I, which is a matrix of all zeros except for the diagonal elements which are all ones. For spreading the analog feedback, one spreading sequence is used for one of the MUBs (e.g., column 2 from MUB B). The particular column and the particular MUB used will be signaled by the base unit to the remote unit. Note that when used for spreading, the average power of a particular OFDM subcarrier should be one, so the actual code used will be these MUBs multiplied by the square root of two.

In the case of D=4 (corresponding to a spreading by a factor of 4), 5 MUBs (the maximum possible in this dimension) includes bases A, B, C, D given as:

$$A = ( \frac{1}{2} ) [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ] , \\ B = ( \frac{1}{2} ) [ \begin{matrix}1 & 1 & 1 & 1 \\ - 1 & - 1 & 1 & 1 \\ - i & i & i & - i \\ - i & i & - i & i\end{matrix} ] , \\ C = ( \frac{1}{2} ) [ \begin{matrix}1 & 1 & 1 & 1 \\ - i & - i & i & i \\ - i & i & i & - i \\ - 1 & 1 & - 1 & 1\end{matrix} ] , \\ D = ( \frac{1}{2} ) [ \begin{matrix}1 & 1 & 1 & 1 \\ i & i & - i & - i \\ 1 & - 1 & - 1 & 1 \\ - i & i & - i & i\end{matrix} ]$$

and also the 4×4 identity matrix, I, which is a matrix of all zeros except for the diagonal elements which are all ones. For spreading the analog feedback, one spreading sequence is used for one of the MUBs (e.g., column 3 from MUB B). The particular column and the particular MUB used will be signaled by the base unit to the remote unit. Note that when used for spreading, the average power of a particular OFDM subcarrier should be one, so the actual code used will be two times these MUBs.

For the case of D=8, 9 MUBs are possible and one example is:

$$A = ( \frac{1}{\sqrt{8}} ) [ \begin{matrix}1 & 1 & 1 & 1 & 1 & 1 & 1 & 1 \\ 1 & - 1 & 1 & - 1 & 1 & - 1 & 1 & - 1 \\ 1 & 1 & - 1 & - 1 & 1 & 1 & - 1 & - 1 \\ 1 & - 1 & - 1 & 1 & 1 & - 1 & - 1 & 1 \\ 1 & 1 & 1 & 1 & - 1 & - 1 & - 1 & - 1 \\ 1 & - 1 & 1 & - 1 & - 1 & 1 & - 1 & 1 \\ 1 & 1 & - 1 & - 1 & - 1 & - 1 & 1 & 1 \\ 1 & - 1 & - 1 & 1 & - 1 & 1 & 1 & - 1\end{matrix} ]$$

$$B = diag ( [ \begin{matrix}1 \\ 1 \\ - i \\ i \\ - 1 \\ 1 \\ - i \\ - i\end{matrix} ] ) A , \\ C = diag ( [ \begin{matrix}1 \\ i \\ - 1 \\ - i \\ - 1 \\ - i \\ - 1 \\ - i\end{matrix} ] ) A , \\ D = diag ( [ \begin{matrix}1 \\ - i \\ 1 \\ i \\ - i \\ - 1 \\ - i \\ 1\end{matrix} ] ) A , \\ E = diag ( [ \begin{matrix}1 \\ 1 \\ - 1 \\ 1 \\ - i \\ - i \\ - i \\ i\end{matrix} ] ) A$$

$$F = diag ( [ \begin{matrix}1 \\ - i \\ - i \\ - 1 \\ i \\ - 1 \\ - 1 \\ - i\end{matrix} ] ) A , \\ G = diag ( [ \begin{matrix}1 \\ - 1 \\ - i \\ i \\ i \\ i \\ 1 \\ 1\end{matrix} ] ) A , \\ H = diag ( [ \begin{matrix}1 \\ - i \\ - i \\ 1 \\ 1 \\ i \\ - i \\ - 1\end{matrix} ] ) A$$

and also includes the D×D identity matrix, I. In the above equations, diag(b) is an matrix of all zeros but with the elements of b on the diagonal. Note that when used for spreading, the average power of a particular OFDM subcarrier should be one, so the actual code used will be these MUBs multiplied by the square root of eight.

The advantages of spreading with a code chosen from a set of MUBs is that the code will be guaranteed to have a low cross-correlation with any code from another MUB set. In particular if a first base unit employs one set of MUBs in a particular sector and a second base unit employs a different set of MUBs in a particular sector, then interference at the first base unit from a remote unit sending feedback to the second base unit will be at a low level due to a guaranteed distance between MUB sets. For example for the spreading of D=4 case given above, say the first base unit in sector one employs MUB A (i.e., a first remote unit in sector one served by the first base uses a code from MUB A to spread their analog feedback) and the second base unit employs MUB C in its sector two (i.e., a second remote unit in sector two served by the second base uses a code from MUB C to spread their analog feedback); then the interference power from the second remote unit received in sector one of the first base station will be suppressed by 1/D=1/4 (or 6.0 dB) relative to the first remote unit's feedback.

While simply spreading with a Walsh code may suffice in many situations, a problem may result with interference from adjacent or nearby sectors/base units that use a same spreading code. In order to eliminate this situation the use of a base-specific long spreading pseudo-random code along with the Walsh code may be utilized. In this situation, each base unit/sector has its own long code. Thus, the spread feedback channel may be further spread with a base-specific code.

On the other hand, the use of a long code with MUBs is a bit more complicated because multiple base units might share the same set of MUBs. For example if a first base unit uses MUB A from a set of MUBs and a second unit station uses MUB B from the same set of MUBs, then these two base units must use the same long code to retain the good cross-correlation properties between two MUBs. However since there is a limited number of MUBs in a set, using a long code to limit interference between groups of base units is still necessary. For example if adjacent base units 1 and 2 use all MUBs from a common set of MUBs, and base units 3 and 4 use all MUBS from a common set of MUBs, then base units 1 and 2 must use a common long code and that common long code must be different than the common long code used by base units 3 and 4.

In one embodiment the allocation of a MUB spreading sequence to a remote unit may be determined by the remote unit from the cell-id or sector-id. In another embodiment the allocation of a MUB spreading sequence to a remote unit may be signaled explicitly by a base-unit.

To further improve on the above technique, each sector of a base unit may be provided with a sector-specific spreading code. The Walsh-spread feedback channel may be further spread with a sector-specific code. For the case of MUB spreading codes, a long code is only needed between sectors if the number of sectors sharing the same time-frequency resource is greater than the number of MUBs in the MUB set.

The base-specific codes may be designed with limited alphabet elements (e.g., QPSK) which provide low complexity spreading and despreading with complexity similar to BPSK spreading (e.g., prior art Walsh codes).

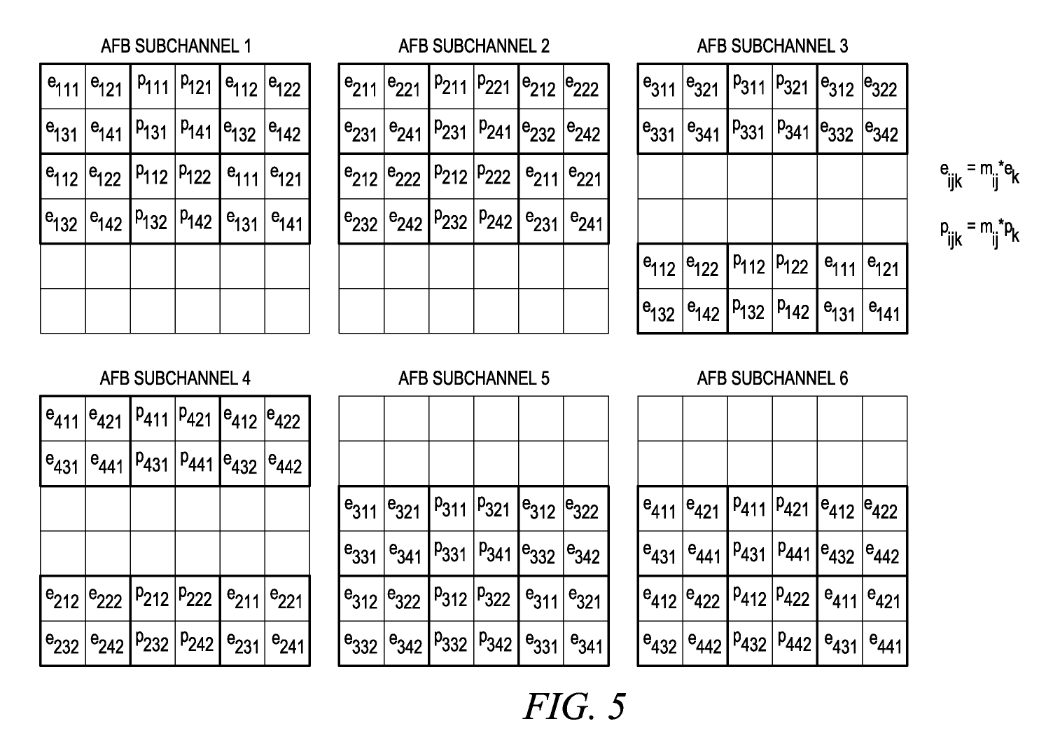

FIG. 5 shows the preferred embodiment of spreading for the analog feedback (AFB) for two base station antennas with a spreading factor of D=4. For example, MUB A from the set of 5 MUBs given above can be used to spread the feedback. The feedback will be constructed using tiles of OFDM subcarriers (shown in the vertical or y dimension) and OFDM symbol times (shown in the horizontal or x dimension).

FIG. 5 shows six analog feedback (AFB) subchannels where in this and subsequent figures the horizontal or x dimension is time and the vertical or y dimension is frequency (although the invention is equally applicable if the time and frequency dimensions are switched). The AFB subchannels all occupy the same time-frequency region and consist of one or more tiles where each tile consists of six OFDM subcarriers by six OFDM symbol times. The six AFB subchannels enable six mobile stations to transmit CDM'd analog feedback symbols to the base station, where each AFB subchannel is assigned to one MS. A MS may be assigned multiple AFB subchannels when the feedback is larger than can fit in a single feedback channel. For example, a MS may be assigned two AFB subchannels when it must feed back two dominant eigenvectors rather than only one. A code division multiplexing (CDM) factor of four is achieved through the use of four MUB sequences. Each smaller square represents a particular OFDM time-frequency symbol, whereas each two-by-two square (denoted with a thicker line) represents a region where one analog feedback symbol eₖ is being spread by a length four MUB sequence. Nothing is transmitted in the empty squares of an AFB subchannel. As a result, each two-by-two square is overlapped in time and frequency by two-by-two squares from three other AFB subchannels (i.e., the CDM factor is 4).

In general, the values to be transmitted on the OFDM symbol times and subcarriers are indicated in the figures by the variable eᵢⱼₖ, which are functions of the analog values e₁ and e₂ and the MUB spreading values as follows:

eᵢⱼₖ=mᵢⱼ×eₖ

where eₖ is the k^{th} analog value to be conveyed by the MS assigned to the AFB subchannel (k=1 or 2 in FIG. 5, for example), mᵢⱼ is the (j,i)^{th} entry of the MUB matrix being used by the base station sector (where j is the row index and i is the column index of the MUB matrix). As mentioned earlier, the MUB matrix being used to spread the analog values may be either signaled explicitly or determined by the mobile station based on a system parameter such as the cell or sector ID. In the case of FIG. 5, there are two analog values to be sent back, e₁ and e₂, that as described above may correspond to the entries of the dominant eigenvector of the measured covariance matrix or may represent an analog encoding of the covariance matrix (e.g., according to methodologies described earlier) or may represent a digital or quantized encoding of the covariance matrix. In another embodiment, the values e₁ and e₂, etc., may represent channel information feedback in the form of a channel response encoded as an analog signal. In another embodiment, the values e₁ and e₂, etc., may represent channel information feedback in the form of a channel response encoded as a digital signal. In another embodiment, the values e₁ and e₂, etc., may represent channel information feedback in the form of an acknowledgement (ACK) or negative acknowledgment (NAK) in HARQ feedback.

Along with spreading the analog feedback, pilot symbols (designated by “Pₖ”) are also spread (the pilot symbol could be any value known to both the base and remote units). The pilot signals transmitted in the structure of FIG. 5 are denoted Pijk as follows:

Pᵢⱼₖ=mᵢⱼ×Pₖ

where Pₖ is the pilot value to be transmitted by the MS assigned to the AFB subchannel.

A different remote unit or mobile station would be assigned a different AFB subchannel to send data and the AFB subchannel will have a code or codes from the MUB associated with it along with time-frequency resources to use. Note that the pilots are adjacent to the analog values which is important to provide good channel estimates which the base unit will use to detect the feedback symbols. Note also that the spreading is done over adjacent subcarriers and symbol times to minimize the effect of channel variations in time and frequency on the despreading of the analog feedback. Although only one tile is shown (6 subcarriers by 6 symbol intervals in FIG. 5), the feedback may be repeated on multiple frequencies (e.g., three tiles, widely-spaced in frequency) to further improve reliability. Note that an important feature of the feedback is alternating e1 and e2 across frequency on a single OFDM symbol to keep the total power of each OFDM symbol equal.

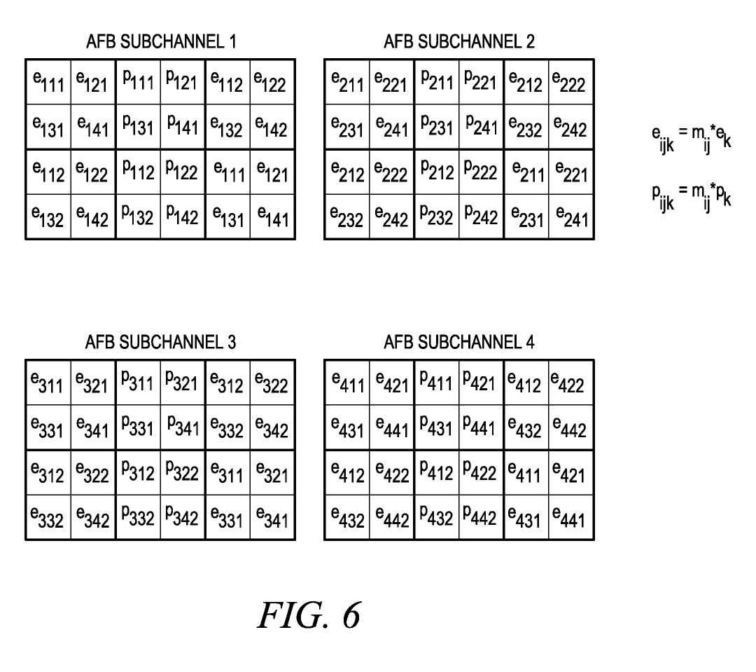

FIG. 6 shows an alternate embodiment for spreading of the analog feedback for two base station antennas with a spreading of D=4. For example, MUB A from the set of 5 MUBs given above can be used to spread the feedback. The main difference in this case is that the tile is now 4 subcarriers by 6 symbol times and four analog feedback subchannels are defined for the 4×6 allocation.

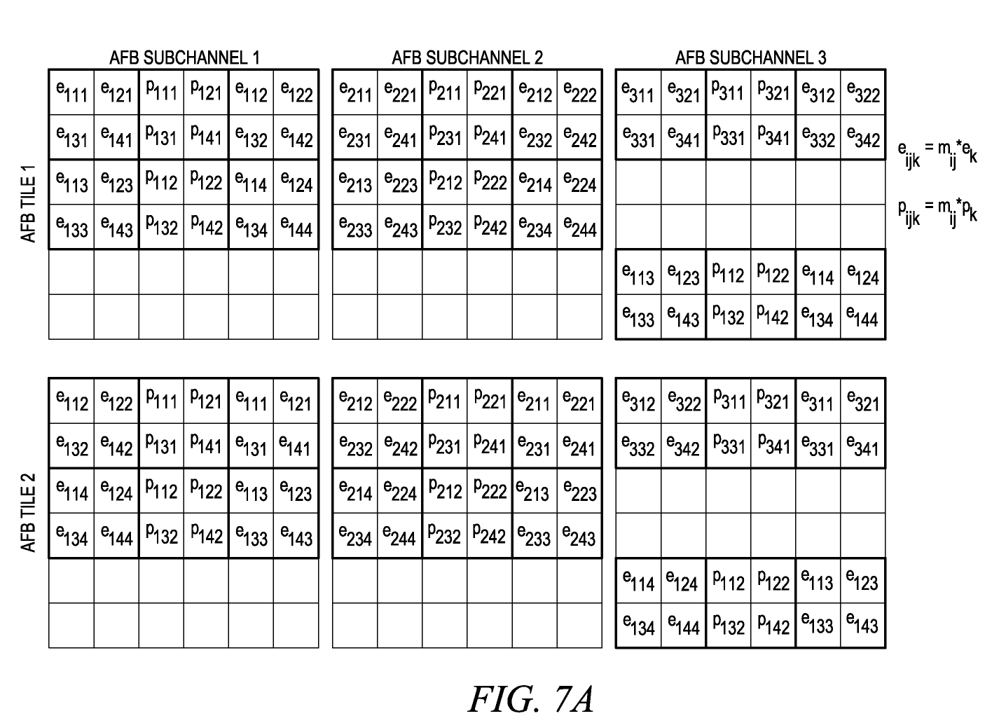

FIG. 7 shows the preferred embodiment of spreading for the analog feedback for four base station antennas with a spreading of D=4. For example, MUB A from the set of 5 MUBs given above can be used to spread the feedback. This case operates much the same as the feedback for two antennas shown in FIG. 5 except that due to the limited space in the tiles, the analog values are not alternated within one tile but instead the alternation happens at the second frequency (i.e., on AFB Tile 2). As in the two antenna case one or more of the tiles for a given AFB subchannel might be repeated in frequency (e.g., AFB Tile 1 could be repeated on a third frequency different from the frequencies used for AFB Tile 1 and AFB Tile 2).

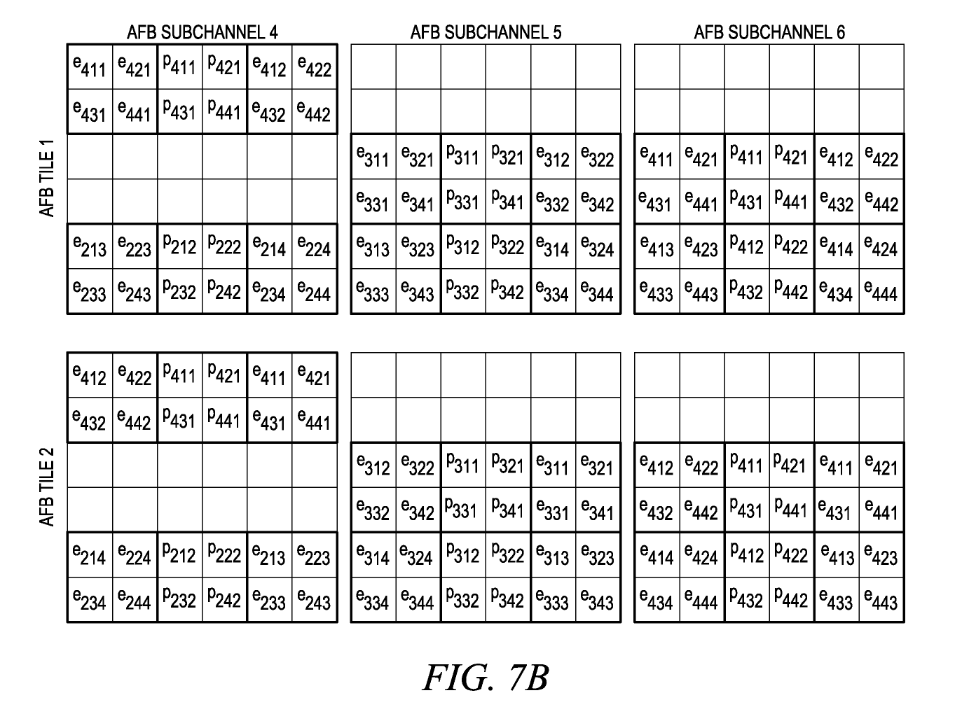

FIG. 8 shows an alternate embodiment for spreading of the analog feedback for four base station antennas with a spreading of D=4. For example, MUB A from the set of 5 MUBs given above can be used to spread the feedback. The main difference in this case is that the tile is now 4 subcarriers by 6 symbol times and four analog feedback subchannels are defined for the 4×6 allocation.

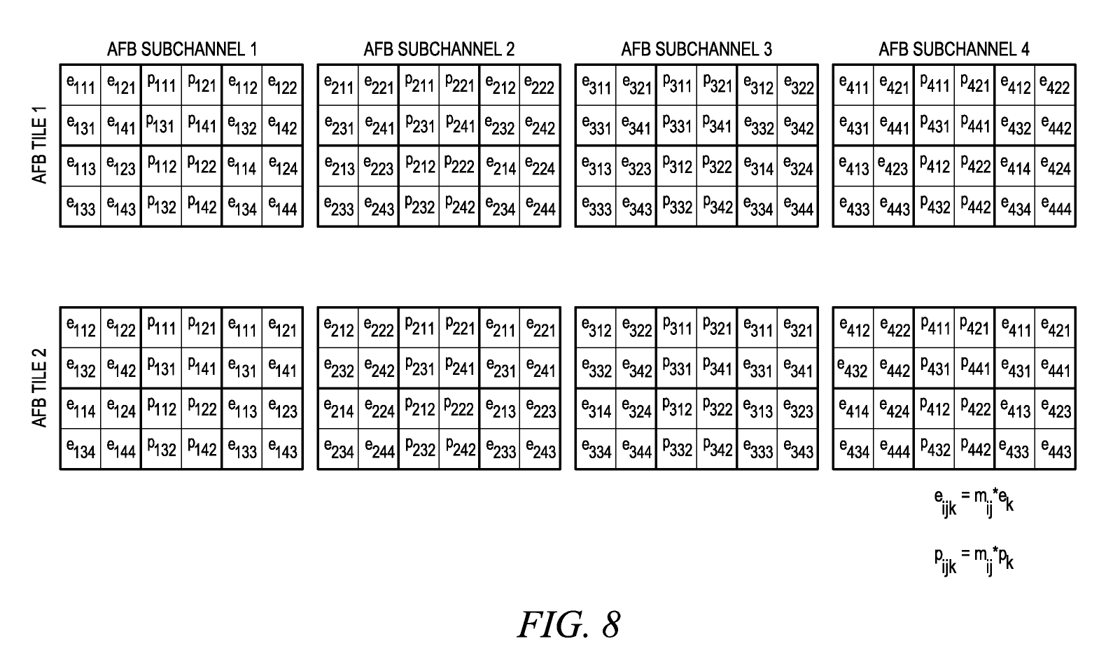

FIG. 9 shows the preferred embodiment of spreading for the analog feedback for eight base station antennas with a spreading of D=4. For example, MUB A from the set of 5 MUBs given above can be used to spread the feedback. This case operates much the same as the two and four antenna cases shown in FIG. 5 and FIG. 7 respectively except that three tiles are used to send the analog data and four analog feedback subchannels are defined. These three tiles will each be sent on different frequencies.

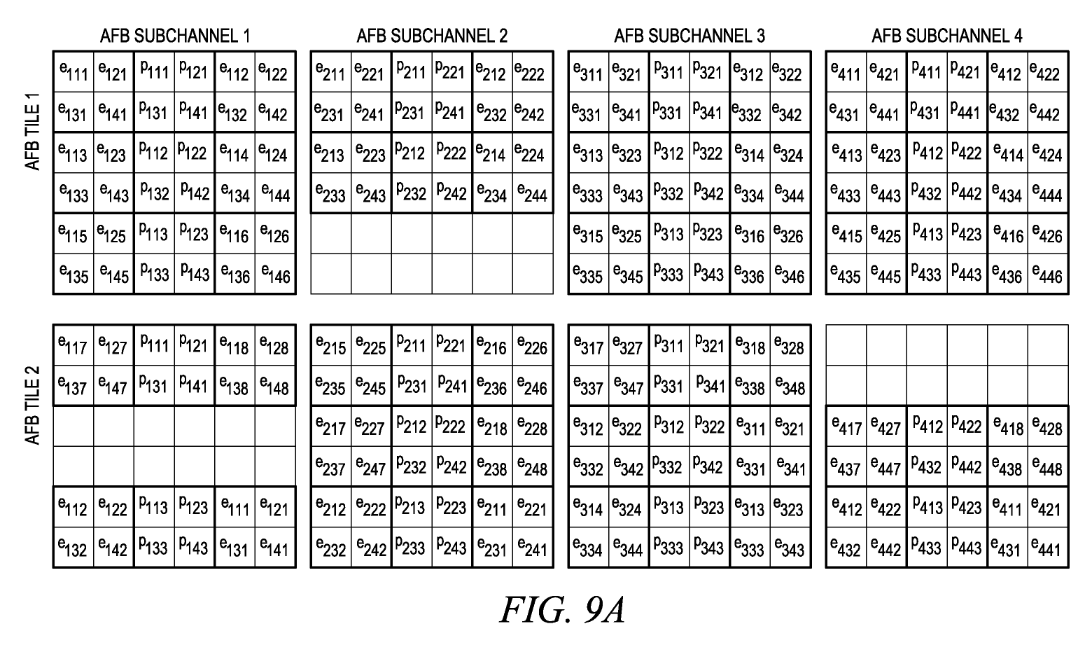

FIG. 10 shows an alternate embodiment for the spreading of the analog feedback for eight base station antennas using a spreading of D=2. For example, MUB A from the set of 3 MUBs shown above for the case of spreading of 2 can be used. The size of the tiles in this case is 4 subcarriers by 6 OFDM symbols and three analog feedback subchannels are defined for the 4×6 allocation.

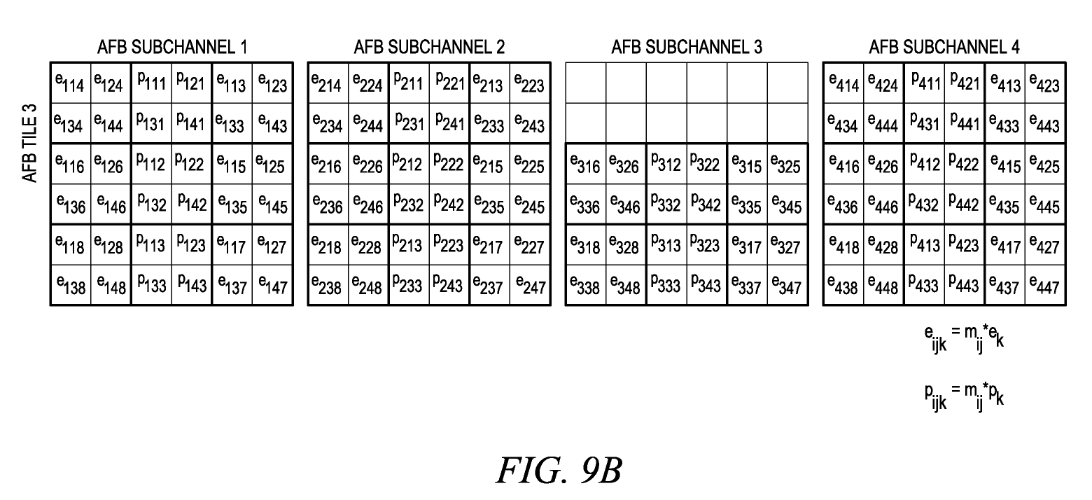

FIG. 11 is a block diagram of a remote unit using uplink feedback channel spreading. Transceiver circuitry 1103 receives an AFB request signal from a base unit on an antenna or an array of antennas 1101 along with downlink pilot symbols. In response to the AFB request, the mobile unit calculates the covariance matrix as a function of the received downlink pilot symbols in the AFB calculation circuitry 1105. The AFB calculation circuitry 1105 then computes the analog feedback values from the covariance matrix as described above. As shown in FIG. 11, spreading circuitry 1107 is provided to spread the analog feedback generated by the AFB calculation circuitry 1105. During operation spreading circuitry 1107 multiplies the analog feedback by a MUB code, a Walsh code, and/or a long code as specified in the AFB request signal sent by the base unit. This spreading may be done as specified above and shown in FIGS. 5 through 10. Once the spreading is done and the AFB signal is created by the spreading circuitry 1107, then the AFB signal is sent to the base unit via the transceiver circuitry 1103.

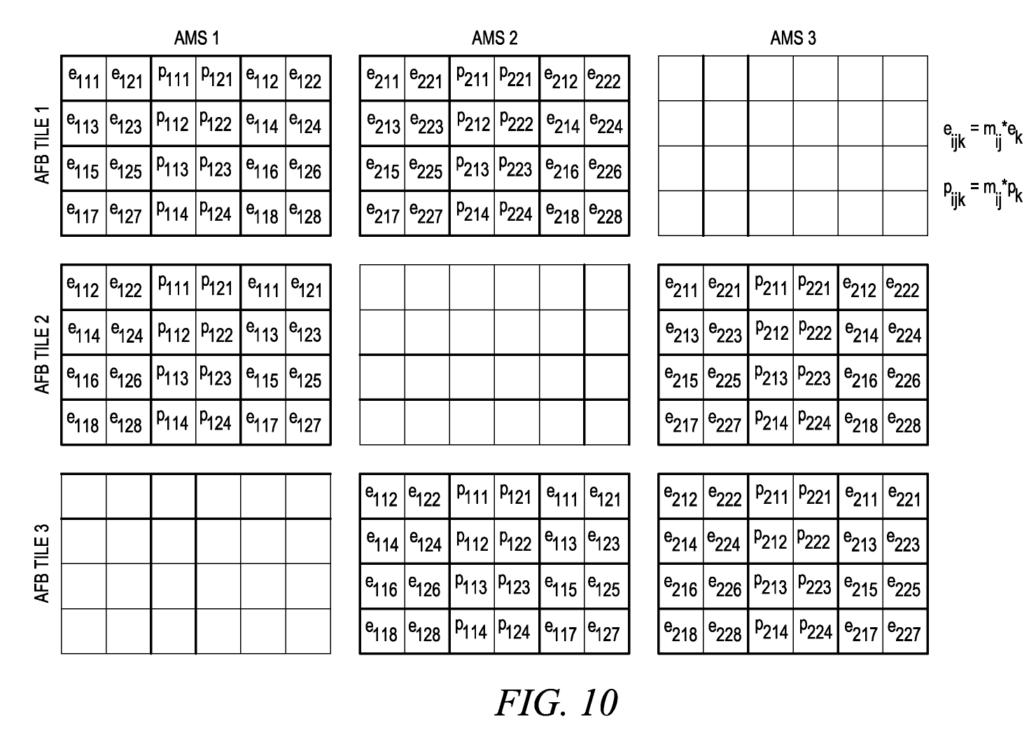

FIG. 12 is a block diagram of a base unit employing uplink feedback channel spreading. The base unit first determines that a mobile unit should send analog feedback along with what frequencies the feedback should be for, which AFB subchannel the mobile should use, and which code from which MUB the mobile should use. This information is sent in an AFB request signal generated by AFB request circuitry 1205. The AFB request signal is provided to the transceiver circuitry 1203 which sends the signal to the remote unit over an antenna or an array of antennas 1201.

In addition to the AFB request signal, pilot symbols might also be sent out of each of the transmit antennas by the transceiver circuitry 1203. In response to the AFB request sent to the remote unit, transceiver circuitry 1203 will receive a spread AFB signal from the mobile unit. The transceiver circuitry 1203 will send the received spread AFB signal to channel estimation circuitry 1207 and AFB data detection circuitry 1209. Channel estimation circuitry 1207 contains a despreader (not shown), and will despread the pilot data within the AFB signal using the appropriate MUB spreading code to obtain channel estimates. These channel estimates are provided to the AFB data detection circuitry 1209 to equalize the data portion of the AFB signal which contains the analog feedback from the mobile. The detected analog feedback is then provided to transmit beamforming circuitry 1211 that uses the analog feedback to beamform data 1213 that is to be sent to the remote unit from the transceiver circuitry 1203.

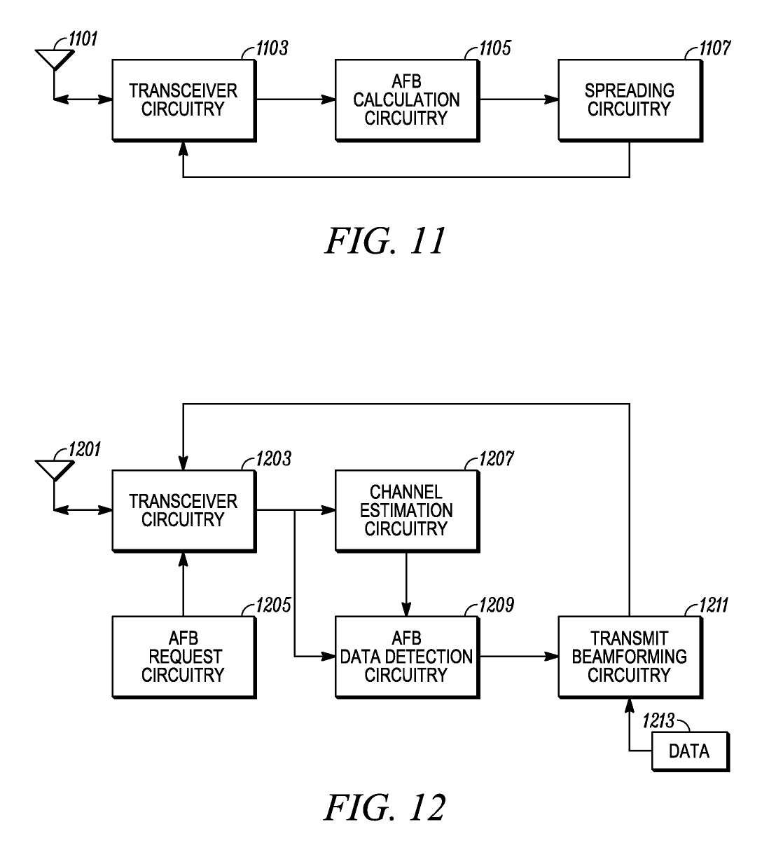

FIG. 13 is a flow chart showing operation of the mobile unit spreading a feedback channel. The logic flow begins at step 1301 where transceiver circuitry 1103 receives a request to supply a feedback of channel information (e.g., digital modulation symbol feedback). As discussed above, the request is received from a base station. Additionally, the request may indicate a spreading code to utilize by the mobile unit. The request may also contain a frequency (subchannel) to use when transmitting the request back to the base station. At step 1303 AFB calculation circuitry 1105 determines the information to feed back to the base station (AFB values). The AFB values are then spread by spreading circuitry 1107 and transmitted with pilots on a proper AFB subchannel to a base unit (step 1309). As discussed above, the spread information may be transmitted across multiple subcarriers in frequency, or multiple symbols in time, or both. The channel information may include a channel response encoded as an analog signal, a covariance matrix, or an eigenvector. Additionally, spreading circuitry may spread pilot information and transmit the pilot information along with the channel information. Spreading may take place utilizing a Walsh code, a mutually unbiased basis, or a long code. When spreading with MUBs, the MUB utilized may be choses from a set of MUBs that utilize a same long code. Thus, the long code utilized by the mobile station may a same long code used by another mobile unit in communication with the base.

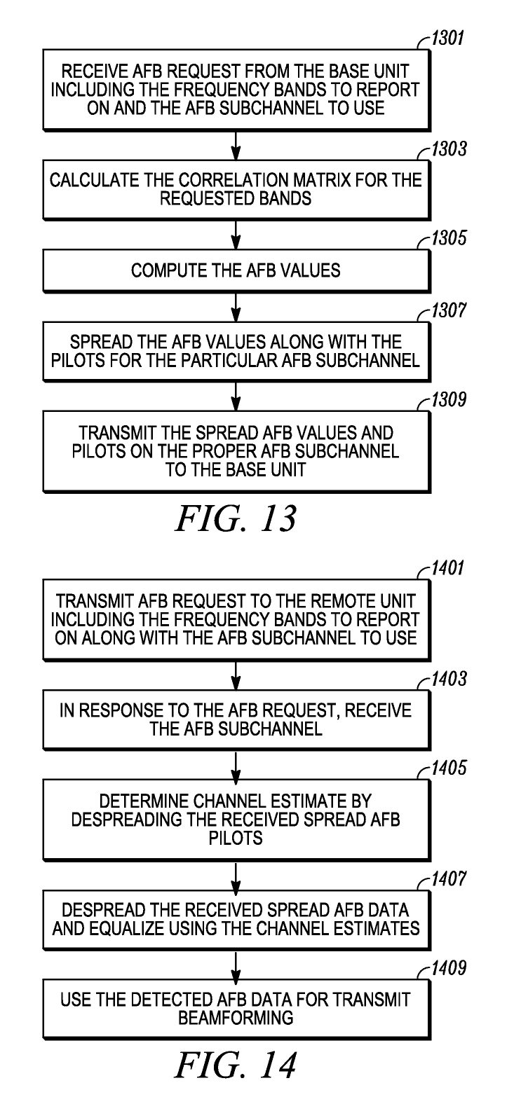

FIG. 14 is a flow chart showing operation of requesting and receiving an AFB subchannel at a base unit when the base unit determines that channel information is needed regarding a channel existing between the base unit and a mobile station. The logic flow begins at step 1401 where transceiver 1203 transmits an AFB request to a remote unit. The AFB request includes a frequency band to report on, a spreading code to use, and an AFB subchannel to use in sending back the report. At step 1403, and in response to the request, transceiver 1203 receives the spread AFB report over the subchannel. Channel estimation circuitry 1207 despreads the AFB pilots and determines a channel estimate from the pilots (step 1405). Additionally, circuitry 1207 despreads the received AFB data and equalizes the data using the channel estimates (step 1407). Finally at step 1409, AFB data detection circuitry uses the AFB report to determine appropriate channel beamforming weights, and instructs circuitry 1211 to use the appropriate weights.

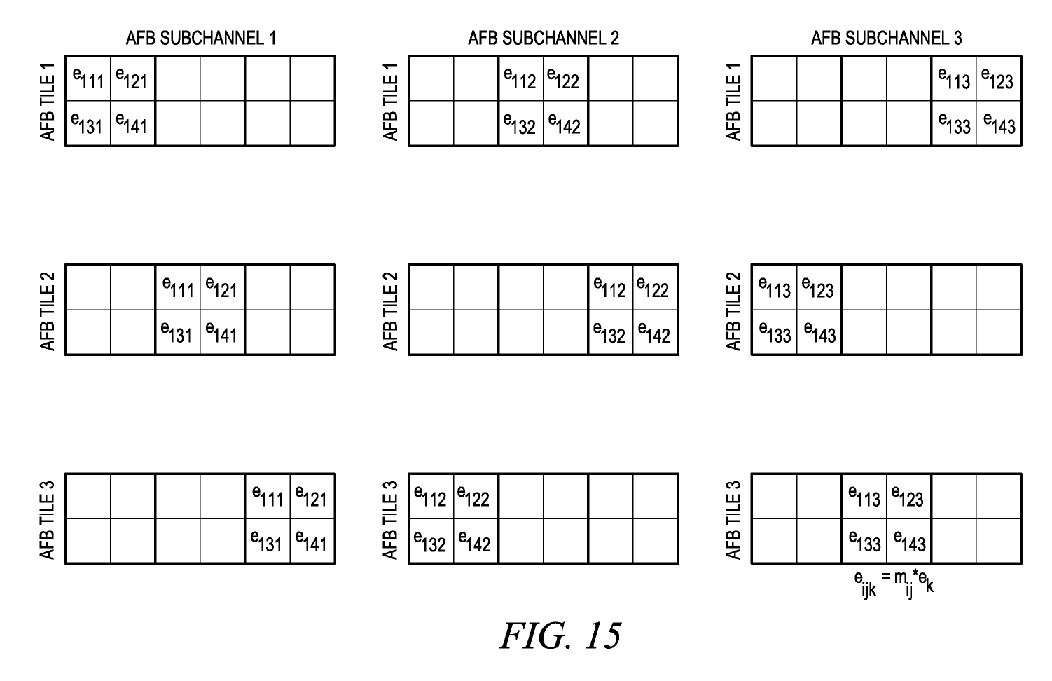

FIG. 15 shows a preferred embodiment of spreading using MUB sequences for modulation symbols (representing information mapped to a digital constellation) with a spreading factor of D=4. For example, MUB A from the set of 5 MUBs given above can be used to spread the feedback. A subchannel will be constructed using tiles of OFDM subcarriers (shown in the vertical or y dimension) and OFDM symbol times (shown in the horizontal or x dimension).

FIG. 15 shows 3 subchannels. The subchannels consist of 3 tiles where each tile consists of 2 OFDM subcarriers by six OFDM symbol times. The 3 subchannels enable 3 mobile stations to transmit modulation symbols to the base station, where each subchannel is assigned to one MS. A MS may also be assigned multiple subchannels. Each smaller square represents a particular OFDM time-frequency symbol, whereas each two-by-two square (denoted with a thicker line) represents a region where one modulation symbol eₖ is spread by a length four MUB sequence. Nothing is transmitted in the empty squares of a subchannel. As a result, each two-by-two square is non-overlapping between any two subchannels.

In general, the values to be transmitted on the OFDM symbol times and subcarriers are indicated in the figures by the variable eᵢⱼₖ, which are functions of the modulation symbols eₖ and the MUB spreading values as follows:

eᵢⱼₖ=mᵢⱼ×eₖ

where eₖ is the k^{th} modulation symbol to be conveyed by the MS assigned to the subchannel (k=1, 2 or 3 in FIG. 15, for example), mᵢⱼ is the (j,i)^{th} entry of the MUB matrix being used by the base station sector. As mentioned earlier, the MUB matrix being used to spread the analog values may be either signaled explicitly or determined by the mobile station based on a system parameter such as the cell or sector ID. In the case of FIG. 15 the modulation symbols e₁, e₂ and e₃ are sent back on subchannels 1, 2 and 3 respectively.

Along with spreading the modulation symbols, pilot symbols may also be spread (not shown in FIG. 15) in a manner similar to that shown in FIG. 5.

A different remote unit or mobile station may be assigned a different subchannel to send data and the mobile station will have a code or codes from the MUB associated with it along with time-frequency resources to use. Note that the spreading is done over adjacent subcarriers and symbol times to minimize the effect of channel variations in time and frequency on the despreading of the modulation symbols.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method for closed loop feedback in a communication system, the method comprising the steps of:
receiving, by a mobile unit, a request to feed back channel information, the request sent from a base station;
determining, by the mobile unit, channel information to feed back to the base station;
spreading, by the mobile unit, the channel information; and
transmitting, by the mobile unit, the spread channel information to the base station.

2. The method of claim 1 wherein the spread channel information is transmitted across multiple subcarriers in frequency or multiple symbols in time or both.

3. The method of claim 1 wherein a spreading code to utilize by the mobile unit is indicated to the mobile unit by the base station.

4. The method of claim 3 wherein a subchannel to utilize when transmitting the spread channel information is indicated to the mobile unit by the base station.

5. The method of claim 1 wherein the channel information to feed back to the base station comprises channel information taken from the group consisting of:
a channel response encoded as an analog signal;
a Hermitian matrix
a function of a covariance matrix; and
an eigenvector.

6. The method of claim 1 further comprising the steps of:
determining pilot information;
spreading the pilot information; and
transmitting, by the mobile unit, the spread pilot information.

7. The method of claim 1 wherein the step of spreading comprises the step of spreading with a Walsh code.

8. The method of claim 1 wherein the step of spreading comprises the step of spreading with a mutually unbiased basis (MUB) code.

9. The method of claim 8 wherein the step of spreading comprises the step of further spreading with a long code.

10. The method of claim 9 wherein a set of base stations using MUBs from a common set of MUBs use a same long code.

11. A method for transmission in a communication system, the method comprising the steps of:
receiving, by a mobile unit, a request for one or more digital modulation symbol feedback, the request sent from a base station;
spreading, by the mobile unit, one or more digital modulation symbols with a spreading code from a mutually unbiased basis across multiple subcarriers in frequency or multiple symbols in time or both; and
transmitting, by the mobile unit, the spread one or more digital modulation symbols.

12. The method of claim 11 wherein the step of spreading comprises spreading with a spreading code provided from the request sent from the base station.

13. The method of claim 11 wherein the step of spreading comprises spreading with a spreading code that is determined from a base station identification.

14. The method of claim 11 wherein the step of spreading comprises the step of spreading with a long code.

15. The method of claim 14 wherein the long code is common for mobile units utilizing a spreading code from same mutually unbiased basis.

16. The method of claim 14 wherein the long code utilized by the mobile station is a same long code used by another mobile unit in communication with the base.

17. A method comprising the steps of:
determining by a base station that channel information is needed regarding a channel existing between the base station and a mobile unit;
sending from the base station, a request for channel feedback to the mobile unit;
in response to the sent channel feedback request, receiving at the base station the channel feedback request in the form of spread information.

18. The method of claim 17 wherein the spread information is received across multiple subcarriers in frequency or multiple symbols in time or both.

19. The method of claim 17 wherein the request for channel feedback comprises an indication of a mutually unbiased basis (MUB) and a column of the MUB for the mobile unit to spread the channel feedback.

20. An apparatus comprising:
a transceiver receiving a request to feed back channel information, the request sent from a base station;
calculation circuitry determining the channel information to feed back to the base station;
spreading circuitry spreading the channel information; and
the transceiver circuitry transmitting the spread channel information to the base station.
